(19) United States
(12) Patent Application Publication
(10) Pub. No.: US 2006/0001675 A1
(43) Pub. Date: Jan. 5, 2006

(54) Plasma display panel

(76) Inventors: Jae-Ik Kwon, Suwon-si (KR); Kyoung-Doo Kang, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/168,212

(22) Filed: Jun. 28, 2005

(30) Foreign Application Priority Data
Jun. 29, 2004 (KR) 10-2004-0049722

(51) Int. Cl. H01J 17/49

(52) U.S. Cl. 345/584; 313/585; 345/583

(57) ABSTRACT

A plasma display panel enhanced light emission efficiency is disclosed. In one embodiment, the PDP includes a rear substrate, a front substrate disposed apart from the rear substrate, a plurality of barrier ribs that define discharge cells together with the rear substrate and the front substrate and disposed between the rear substrate and the front substrate, a plurality of sustain electrode pairs extended across the discharge cells, and a plurality of address electrodes extended across the discharge cells to cross the sustain electrode pairs. The PDP also includes a first dielectric layer that covers the address electrodes, a second dielectric layer that covers the sustaining electrode pairs, a fluorescent layer disposed in each discharge cell and a discharge gas filled in the discharge cells, wherein the barrier ribs comprise vertical units formed in a direction in which the address electrodes are extended, and horizontal units that cross the vertical units. Each of the sustain electrodes comprises a bus electrode extending across the discharge cells and a discharge electrode, wherein the discharge electrode includes i) a main body unit disposed apart from the bus electrode toward the center of each discharge cell and ii) connection units that connect he main body unit and the bus electrode, and the relative width ratio of the connection units to the vertical units is in a range of about 3/7 to about 6/7.

### CROSS-REFERENCE TO RELATED PATENT APPLICATIONS

This application claims the benefit of Korean Patent Application No. 10-2004-0049722, filed on Jun. 29, 2004, in the Korean Intellectual Property Office, the disclosure of which is incorporated herein in its entirety by reference.

### BACKGROUND OF THE INVENTION

1. Field of the Invention

The present invention relates to a plasma display panel, and more particularly, to a plasma display panel that can improve luminous efficiency.

2. Description of the Related Technology

Plasma display panels (PDPs) have drawn attention as devices which can replace conventional cathode ray tubes (CRT). PDPs are devices which obtain an image by exciting a fluorescent material formed in a predetermined pattern by ultraviolet rays generated from a discharge gas sealed in a space formed by two substrates on which a plurality of electrodes for applying a voltage are formed.

FIG. 1 is a plan view of barrier ribs 30 and sustaining electrodes 31 of a conventional PDP. Referring to FIG. 1, a plurality of discharge cells 80 in a matrix having a rectangular shaped cross-sectional surface are defined by the barrier ribs 30 which include horizontal units 30a and vertical units 30b. Also, sustaining electrodes 31 disposed across the discharge cells 80 are formed in the PDP. Each of the sustaining electrodes 31 includes a bus electrode 41 and a transparent electrode 51. Also, the transparent electrode 51 includes a main body unit 51b and connection units 51a that connect the main body unit 51b and the bus electrode 41. The main body units 51b, on which main discharges are generated, are disposed apart from each other in a direction toward the center of the discharge cells 80 and the connection units 51a are disposed on an upper part of the vertical units 30b.

As shown in FIG. 1, each of the connection units 51a has a width (a) and each of the vertical units 30b has a width (b). If the width a of the connection units 51a is excessively small, the brightness of the PDP is reduced since the resistance of the PDP increases remarkably, thereby reducing the luminous efficiency. On the other hand, if the connection unit width (a) is excessively large relatively to the width (b) of the vertical units 30b, the opening ratio of the PDP is reduced since the connection units 51a are protruded from sides of the vertical units 30b, and the luminous efficiency of the PDP is reduced since the discharge current increases drastically.

### SUMMARY OF CERTAIN INVENTIVE ASPECTS

One aspect of the present invention provides a plasma display panel that can improve the light emission efficiency.

Another aspect of the present invention provides a plasma display panel comprising a rear substrate; a front substrate disposed apart from the rear substrate; a plurality of barrier ribs that define discharge cells together with the rear substrate and the front substrate and disposed between the rear substrate and the front substrate; a plurality of sustaining electrode pairs extended across the discharge cells; a plurality of address electrodes extended across the discharge cells to cross the sustaining electrode pairs; a first dielectric layer that covers the address electrodes; a second dielectric layer that covers the sustaining electrode pairs; a fluorescent layer disposed in each discharge cell; and a discharge gas filled in the discharge cells, wherein the barrier ribs comprise vertical units formed in a direction in which the address electrodes are extended and horizontal units that cross the vertical units, each of the sustain electrodes comprises a bus electrode extending across the discharge cells and a discharge electrode, wherein the discharge electrode includes i) a main body unit disposed apart from the bus electrode toward the center of each discharge cell, and ii) connection units that connect the main body unit and the bus electrode, and wherein the relative width ratio of the connection units to the vertical units is in a range of about 3/7 to about 6/7.

In one embodiment, the connection units can be disposed on an upper part of the vertical units. In one embodiment, an imaginary axis of symmetry of the connection units in a width direction and an imaginary axis of symmetry of the vertical units in a width direction can be aligned in a vertical direction to the front substrate. In one embodiment, the connection units can be disposed in a shadow region of the vertical units in a vertical direction to the front substrate.

In one embodiment, the luminous efficiency can be maximized at the relative ratio of the width of the connection units to the width of the vertical units at a range of about 3/7 to about 6/7.

In one embodiment, the brightness of the PDP can be increased by the improved opening ratio since the connection units are disposed on an upper part of the vertical units.

### BRIEF DESCRIPTION OF THE DRAWINGS

Embodiments of the present invention will be described with reference to the attached drawings.

FIG. 1 is a plan view of barrier ribs and sustaining electrodes of a conventional PDP.

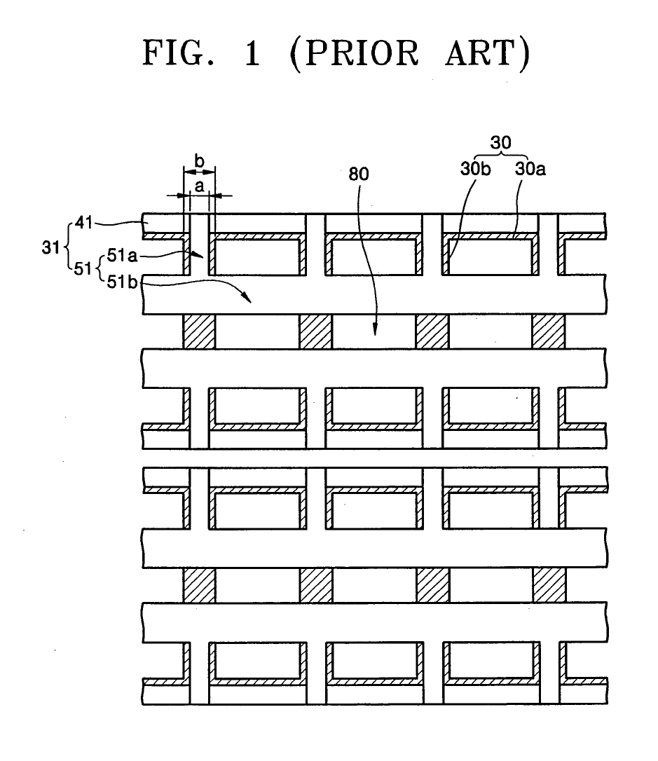

FIG. 2 is a partial cutaway exploded perspective view of a PDP according to one embodiment of the present invention.

FIG. 3 is a plan view of barrier ribs and sustaining electrodes of FIG. 2.

FIG. 4 is a graph showing the measurement result of the luminous efficiency by varying the relative ratio of the width of the vertical units to the width of the connection units of the PDP of FIG. 2.

### DETAILED DESCRIPTION OF CERTAIN INVENTIVE EMBODIMENTS

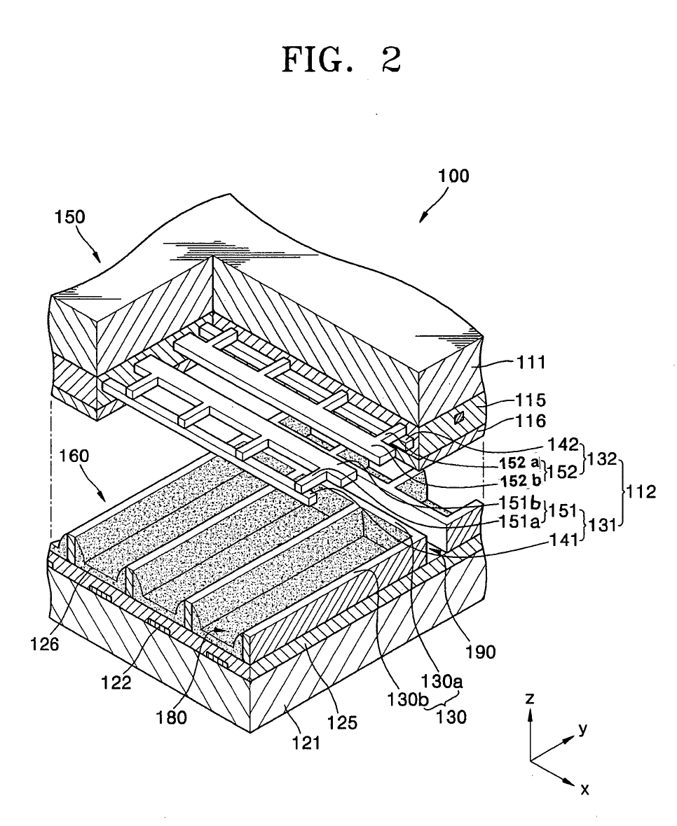

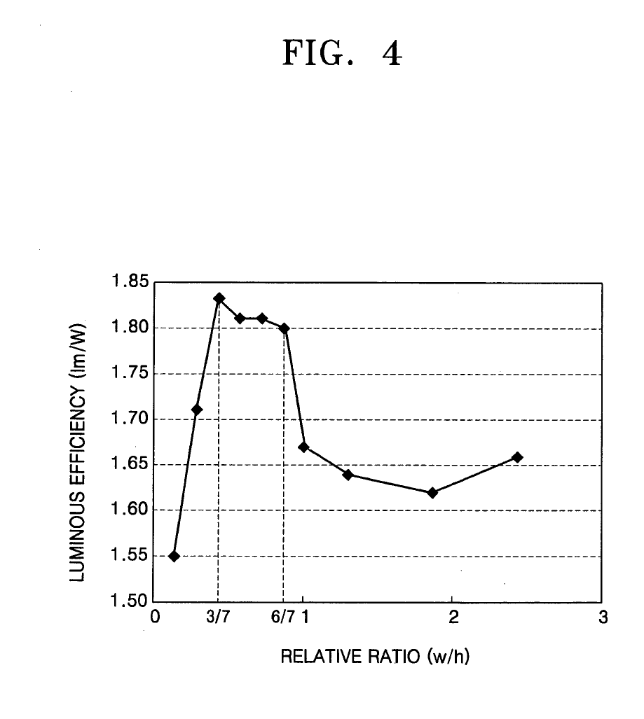

Embodiments of the present invention will now be described with reference to FIGS. 2 and 4. Like reference numerals refer to like elements throughout the drawings and the specification.

FIG. 2 is a partial cutaway exploded perspective view of a PDP 100 according to one embodiment of the present invention.

Referring to FIG. 2, the PDP 100 comprises a rear substrate 121, a front substrate 111 disposed apart from the rear substrate 121, a plurality of barrier ribs 130 that define discharge cells 180 together with the front substrate 111 and the rear substrate 121 and disposed between the front substrate 111 and the rear substrate 121. The PDP 100 also includes a plurality of sustaining electrode pairs 112 extended across the discharge cells 180, a plurality of address electrodes 122 extended across the discharge cells 180 to cross the sustaining electrode pairs 112 in each discharge cell 180. The PDP 100 further includes a first dielectric layer 125 that covers the address electrodes 122, a second dielectric layer 115 that covers the sustaining electrode pairs 112, a fluorescent layer 126 disposed in each discharge cell 180, and a discharge gas filled in each of the discharge cells 180.

The sustaining electrode pairs 112 are disposed on the front substrate 111. In one embodiment, the front substrate 111 can be formed of a transparent material in which glass is a typical substance.

The sustaining electrode pairs 112 represent a pair of sustaining electrodes 131 and 132, formed on a rear surface of the front substrate 111, configured to generate a discharge. The sustaining electrode pairs 112 are generally arranged in parallel at a predetermined distance from each other on the front substrate 111. Each of the sustaining electrode pairs 112 includes an X electrode 131 and a Y electrode 132.

The X and Y electrodes 131 and 132, respectively, include discharge electrodes 151 and 152 and bus electrodes 141 and 142. In one embodiment, the discharge electrodes 151 and 152 can be formed of a conductive transparent material that can generate discharges and that does not interrupt the progress of light generated from a fluorescent layer 126 toward the front substrate 111. In one embodiment, the transparent conductive material can be indium tin oxide (ITO). The transparent conductive material such as the ITO generally has a large resistance. Therefore, if the discharge electrodes 151 and 152 are formed using only transparent electrodes, a driving power can be increased due to a large voltage drop in a length direction of the transparent electrodes and a response time is delayed. To solve this problem, the bus electrodes 141 and 142 formed of a metal having a narrow width are provided on the transparent electrodes.

The address electrodes 122 are formed, to cross the X electrode 131 and the Y electrode 132 of the front substrate 111, on the rear substrate 121 facing the front substrate 111.

The address electrodes 122 are formed to generate an address discharge which facilitates a sustain discharge between the X electrode 131 and the Y electrode 132. More specifically, the address electrodes 122 reduce a discharge voltage for generating a sustaining discharge. The address discharge occurs between the Y electrode 132 and the address electrode 122. When the address discharge is completed, positive ions are accumulated on the Y electrode 132 and electrons are accumulated on the X electrode 131, thereby facilitating the sustaining discharge between the X electrode 131 and the Y electrode 132.

A space formed by a pair of the X electrode 131 and the Y electrode 132 and the address electrodes 122 crossing the X and Y electrodes 131 and 132 is a unit discharge cell 180 that forms a discharge unit.

A first dielectric layer 125 covering the address electrodes 122 is formed on the rear substrate 121. In one embodiment, the first dielectric layer 125 is formed of a dielectric that can prevent the address electrodes 122 from being damaged by colliding with positive ions or electrons during discharging, and can induce electrons. In one embodiment, the dielectric can be PbO, B₂O₃, or SiO₂, etc.

A second dielectric layer 115 covering the sustain electrode pairs 112 is formed on the front substrate 111. In one embodiment, the second dielectric layer 115 is formed of a dielectric that can prevent a direct communication between the X electrode 131 and the adjacent Y electrode 132 during the sustaining discharge. The second dielectric layer 115 can prevent the X electrode 131 and the Y electrode 132 from being damaged by the direct collision between positive ions or electrons with the sustain electrodes 131 and 132. Furthermore, the second dielectric layer 115 can accumulate wall charge by inducing the charges. In one embodiment, the dielectric can be PbO, B₂O₃, or SiO₂, etc.

Also, a protection layer 116, conventionally formed of MgO, for example, is formed on the second dielectric layer 115. The protection layer 116 prevents the second dielectric layer 115 from being damaged by collisions from positive ions or electrons during discharging, has high light transmittance, and generates a lot of secondary electrons.

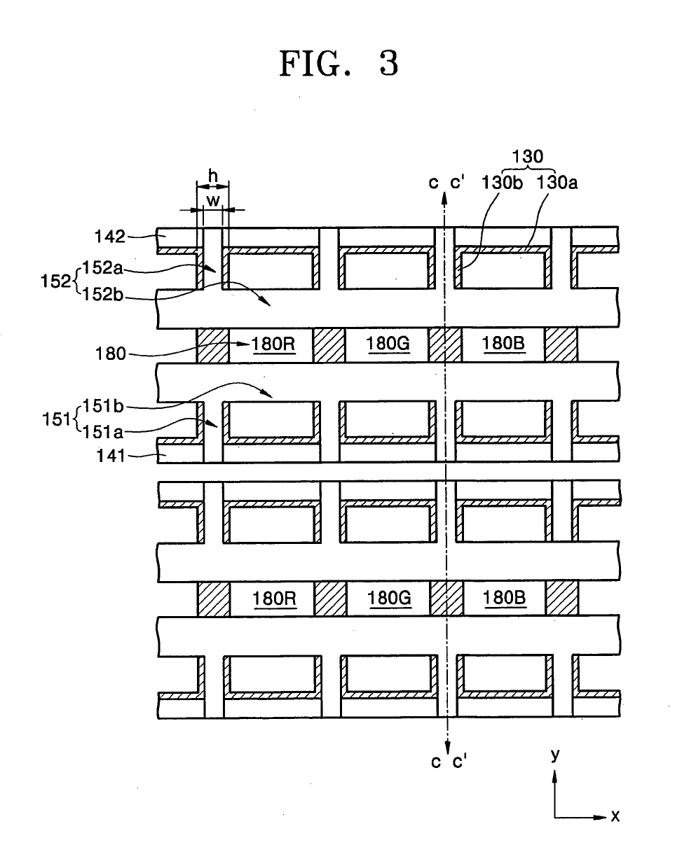

Barrier ribs 130 are formed between the first dielectric layer 125 and the second dielectric layer 115. The barrier ribs 130 maintain a discharge distance, define discharge cells of red 180R, green 180G, and blue 180B light, and prevent electrical and optical cross talk between the adjacent discharge cells 180. As depicted in FIGS. 2 and 3, the barrier ribs 130 include vertical units 130b formed in a direction (y direction) in which the address electrodes 122 are extended, and horizontal units 130a formed to cross the vertical units 130b. In one embodiment, a non-discharge region 190 is formed between the horizontal units 130a adjacent to each other in a direction (y direction) in which the address electrodes 122 are extended since the horizontal units 130a are formed in a double barrier rib. The non-discharge region 190 increases the contrast of the PDP and also can be used as a passage to exhaust an impure gas.

The fluorescent layers 126 of red, green, and blue emitting colors are coated on side surfaces of the barrier ribs 130 and on the entire surface of the first dielectric layer 125 on which the barrier ribs 130 are not formed.

In one embodiment, the fluorescent layer 126 contains a substance that generates visible light by receiving ultraviolet rays. The fluorescent layer 126 formed in a sub-pixel that generates red light includes a fluorescent material such as Y(V,P)O₄:Eu. The fluorescent layer 126 formed in a sub-pixel that generates green light includes a fluorescent material such as Zn₂SiO₄:Mn, or YBO₃:Tb. The fluorescent layer 126 formed in a sub-pixel that generates blue light includes a fluorescent material such as BAM:Eu.

Discharge gases are filled in the discharge cells 180 and sealed. In one embodiment, the discharge gases include a gas selected from Ne, He, Xe, and a gas mixture of these gases.

In one embodiment, the discharge electrodes 151 and 152, respectively, include main body units 151b and 152b and connection units 151a and 152a. Each of the main body units 151b and 152b are disposed toward the center of the discharge cells 180 from the bus electrodes 141 and 142. Each of the connection units 151a and 152a connects the bus electrodes 141 and 142 and the main body units 151b and 152b. Also, each of the connection units 151a and 152a can be disposed on each upper part of the vertical units 130b of the barrier ribs 130 so as to make the voltage uniform applied to the main body units 151b and 152b connected to the bus electrodes 141 and 142 and for structural stability. Also, the bus electrodes 141 and 142 are formed on an upper part of the horizontal units 130a to increase the opening ratio. In one embodiment, the main body units 151b and 152b and the connection units 151a and 152a can be integrally formed to simplify the manufacturing process.

The connection units 151a and 152a are generally disposed in shadow regions of the vertical units 130b in a vertical direction (z direction) to the front substrate 111 as shown in FIG. 3. In one embodiment, the connection units 151a and 152a are narrower than and aligned with the vertical units 130b so as not to block the visible light emitting path as shown in FIG. 3. Otherwise, the connection units 151a and 152a, although formed of a transparent material, can not transmit 100% of the visible light resulting in the reduction of the opening ratio of the PDP 100, thereby reducing the brightness of the PDP.

In one embodiment, an imaginary axis of symmetry C-C of the connection units 151a and 152a in a width direction and an imaginary axis of symmetry C′-C′ of the vertical units 130b in a width direction are aligned in a vertical direction (z direction) to the front substrate 111 as shown in FIG. 3. Generally, the sustain electrodes 131 and 132 are formed when the upper plate 150 is manufactured and the barrier ribs 130 are formed when the lower plate 160 is manufactured. By aligning the C-C axis with the C′-C′, the connection units 151a and 152a and the vertical units 130b can be aligned correctly when the upper plate 150 and the lower plate 160 are coupled after separate manufacturing.

The operation of the PDP 100 according to one embodiment will now be described.

An address discharge is generated by applying an address voltage between the address electrodes 122 and the Y electrode 132. As a result of the address discharge, a discharge cell 180, in which a sustain discharge will be generated, is selected.

Afterward, when a sustain discharge voltage is applied between the X electrode 131 and the Y electrode 132 of the selected discharge cell 180, a sustain discharge is generated by colliding the positive ions accumulated on the Y electrode 132 with the electrons accumulated on the X electrode 131. Ultraviolet rays are emitted by reducing the energy level of the discharge gas excited during the main discharge. The ultraviolet rays excite the fluorescent layer 126 coated in the discharge cell 180, and visible light is generated by reducing the energy level of the fluorescent layer 126, thereby displaying an image.

As described above, the width “w” of the connection units 151a and 152a of the discharge electrodes affect the luminous efficiency of the PDP 100. That is, if the width “w” of the connection units 151a and 152a is excessively small, the resistance of the PDP remarkably increases resulting in the reduction of the brightness and eventually the luminous efficiency of the PDP 100. Furthermore, if the width “w” is excessively great, the opening ratio of the PDP is reduced and the discharge current increases, resulting in reducing the luminous efficiency of the PDP 100. In one embodiment, the opening ratio and the discharge current of the PDP 100 are affected not only by the width “w” of the connection units 151a and 152a but also by the width “h” of the vertical units 130b of the barrier ribs 130. For example, if the width “h” of the vertical units 130b is large, the width “w” of the connection units 151a and 152a does not affect the opening ratio of the PDP since the connection units 151a and 152a can be disposed in a shadow region of the vertical units 130b. One embodiment of the invention provides a ratio, which can maximize the luminous efficiency of the PDP, of the width “h” of the vertical units 130b to the width “w” of the connection units 151a and 152a.

FIG. 4 is a graph showing the measurement results of the luminous efficiency of the PDP 100 by varying the width “w” of the connection units from 10 μm to 170 μm after fixing the width “h” of the vertical units 130b at 70 μm. The Equation 1 defines the luminous efficiency of the PDP. Here, the power consumption on is a measured power consumption of the PDP when a power is applied to the sustain electrodes and the address electrodes. Also, the power consumption off is a measured power consumption when a power is applied to only the sustain electrodes. In the case of the power consumption off, the value remains almost constant at 77 W. Also, the display area is 0.50 m².

$$η = \frac{π \times Area \times brightness}{power consumtion ( on ) - power consumtion ( off )} \qquad Equation 1$$

where η is luminous efficiency, and the Area is a display area.

Referring to FIG. 4, in case of the relative ratio w/h being less than about 3/7, the luminous efficiency is small. This denotes that the brightness of the PDP is reduced due to the increase in the resistance between the bus electrodes 141 and 142 and the connection units 151a and 152a when the width “w” of the connection units 151a and 152a is excessively small. Also, when the relative ratio w/h is greater than about 6/7, the luminous efficiency is reduced since the opening ratio is reduced by the connection units 151a and 152a and the discharge current is increased. In one embodiment, the relative ratio w/h in a range of about 3/7 to about 6/7 can maximize the luminous efficiency of the PDP. In this embodiment, the width w of the connection units 151a and 152a may be in a range of about 30 μm to about 60 μm and the width h of the vertical units 130b is in a range of about 100 μm to about 350 μm.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A plasma display panel, comprising:
a rear substrate;
a front substrate disposed apart from the rear substrate;
a plurality of barrier ribs, disposed between the rear substrate and the front substrate, which define discharge cells together with the rear substrate and the front substrate;
a plurality of sustain electrode pairs extended across the discharge cells;
a plurality of address electrodes extended across the discharge cells to cross the sustain electrode pairs;
a first dielectric layer that covers the plurality of address electrodes;
a second dielectric layer that covers the plurality of sustain electrode pairs;
a fluorescent layer disposed in each of the discharge cells; and
a discharge gas filled in the discharge cells, wherein
the barrier ribs comprise vertical units formed in a direction in which the address electrodes are extended, and horizontal units that cross the vertical units, and
each of the sustain electrodes comprises a bus electrode extending across the discharge cells and a discharge electrode, wherein the discharge electrode includes i) a main body unit disposed apart from the bus electrodes toward the center of each discharge cell and ii) connection units that connect the main body unit and the bus electrode, and
wherein the relative width ratio of the connection units to the vertical units is in a range of about 3/7 to about 6/7.

2. The plasma display panel of claim 1, wherein the connection units are disposed on an upper part of each of the vertical units.

3. The plasma display panel of claim 2, wherein an imaginary axis of symmetry of the connection units in a width direction and an imaginary axis of symmetry of the vertical units in a width direction are aligned in a vertical direction to the front substrate.

4. The plasma display panel of claim 2, wherein the connection units are disposed in shadow regions of the vertical units in a vertical direction to the front substrate.

5. The plasma display panel of claim 2, wherein each of the connection units is disposed on an upper part of each of the vertical units.

6. The plasma display panel of claim 1, wherein the main body units are formed of a transparent material.

7. The plasma display panel of claim 1, wherein each of the connection units is formed of a transparent material.

8. The plasma display panel of claim 1, wherein the main body unit and the connection units are integrally formed.

9. The plasma display panel of claim 1, wherein the width of each connection unit is in a range of about 30 μm to about 60 μm.

10. The plasma display panel of claim 1, wherein the width of each vertical unit is in a range of about 100 μm to about 350 μm

11. The plasma display panel of claim 1, wherein the connection units are disposed substantially perpendicular to the bus electrodes.

12. The plasma display panel of claim 1, wherein the main body units are disposed substantially parallel to the bus electrodes.

13. The plasma display panel of claim 1, wherein the bus electrodes are disposed on an upper part of each of the horizontal units.

14. A plasma display panel, comprising:
a plurality of barrier ribs each including a first pair of sides and a second pair of sides, wherein the two pairs define a discharge cell, and wherein at least one side of the first pair has a first width; and
a plurality of sustain electrodes each comprising a bus electrode and a discharge electrode, wherein the discharge electrode includes i) a body unit substantially parallel to the bus electrode and ii) connection units configured to connect the body unit and the bus electrode, wherein the connection units are substantially parallel to the at least one side of the first pair, and wherein at least one of the connection units has a second width,
wherein the ratio of the second width to the first width is in a range of about 3/7 to about 6/7.

15. The plasma display panel of claim 14, wherein the second width is in a range of about 30 μm to about 60 μm.

16. The plasma display panel of claim 14, wherein the first width is in a range of about 100 μm to about 350 μm

17. A plasma display panel, comprising:
a plurality of barrier ribs that define discharge cells, each barrier rib including vertical units formed in a direction in which address electrodes are extended and horizontal units substantially perpendicular to the vertical units, wherein at least one of the vertical units has a first width; and
a plurality of sustain electrodes extended across the discharge cells, each of the sustain electrodes comprises a bus electrode extending across the discharge cells and a discharge electrode, wherein the discharge electrode includes i) a main body unit disposed apart from the bus electrodes toward the center of each discharge cell and ii) connection units that connect the main body unit and the bus electrode, and wherein at least one of the connection units has a second width,
wherein the ratio of the second width to the first width has a certain value determined so as to maximize the luminous efficiency of the PDP.

18. The plasma display panel of claim 17, wherein the value is in a range of about 3/7 to about 6/7.

19. The plasma display panel of claim 18, wherein the first width is in a range of about 100 μm to about 350 μm, and wherein the second width is in a range of about 30 μm to about 60 μm.

20. The plasma display panel of claim 17, wherein the value is determined based on at least one of i) the resistance between the bus electrode and the connection units, and ii) the opening ratio of the PDP.
